(19) United States
(12) Patent Application Publication
(10) Pub. No.: US 2022/0036416 A1
(43) Pub. Date: Feb. 3, 2022

(54) VIRTUAL ASSISTED LIVING PLATFORM

(71) Applicant: Healthcare Integrated Technologies Inc., Knoxville, TN (US)

(72) Inventors: Kenneth M. GREENWOOD, Davenport, FL (US); Scott Michael BORUFF, Knoxville, TN (US); Jurgen VOLLRATH, Sherwood, OR (US)

(21) Appl. No.: 17/391,994

(22) Filed: Aug. 2, 2021

Related U.S. Application Data
(60) Provisional application No. 63/103,421, filed on Aug. 3, 2020.

(51) Int. Cl. G06Q 30/06; G06Q 50/00; G06Q 30/02; G06F 3/0482

(52) U.S. Cl. CPC G06Q 30/0605; G06Q 30/0641; G06Q 10/20; G06Q 30/0282; G06F 3/0482; G06Q 50/01

(57) ABSTRACT

In an assisted living platform, users are provided with a dashboard for capturing their personal details, preferences and service needs, and service providers can provide details about themselves and the services they are able to provide.

### FIELD OF THE INVENTION

The invention relates to home care.

### BACKGROUND OF THE INVENTION

Many people, especially seniors, are in need of assistance with daily activities. This may involve work that needs to be done around the house, chores that need to be accomplished, and physical and mental well-being.

### SUMMARY OF THE INVENTION

The present invention proposes a software platform or portal implemented as a mobile web app or a downloadable software app (collectively referred to herein as App) that allows people to interact with one another, offer services, and request assistance.

These services may be paid services for taking care of certain activities, e.g. yardwork, house cleaning, home maintenance, shopping and home delivery, meals, etc.

The services may include professional services that are provided virtually or face-to-face, e.g., insurance, medical services, legal services.

The services may also include wellness and entertainment activities, such as on-line gaming with a focus on interacting with others, exercise activities (both individual and group exercises), and socializing activities, e.g., where people may offer to do counseling or socializing with one or more other individuals. These include both paid or free services.

According to the invention there is provided a service and interaction platform, which may be implemented as an App, that includes a registration page for capturing user information. The user information may include payment information insofar as the provider requires compensation for service.

Further, according to the invention, there is provided a system for providing service support, comprising a portal that defines a service provider dashboard for capturing service provider details, and service requester dashboard for submitting a request for services, a processor coupled with memory that includes machine readable code defining an algorithm, for allocating one or more service providers capable of addressing the service request.

The portal (also referred to herein as a customer access platform) may include one or more lists of services that the service requester can select from, wherein the services include social interactions as part of social groups and gatherings that have live or virtual get-togethers.

The service requester dashboard may include a satisfaction feedback page for rating services that users have requested. The service requester dashboard may further include a capture page for capturing one or more of name, age, gender, and interests of the user, and may also include a payment capture page for paying for paid services.

The service provider details may include availability information and location information of the provider. It may also include one or more of name, gender, and user preferences of the service provider. The service provider details may further include fee information for the service providers' services.

Still further, according to the invention, there is provided a method for improving the life of users, comprising providing an engagement App that supports service providers in listing their services, and supports users in selecting from available services, with both parties having the opportunity to provide at least one of gender and age-related information to allow personal preferences to be included by service providers in their offerings, and personal preferences to be included by users in selecting a service provider, the method further providing a rating service to allow users to provide feedback on the service.

The services may include, home delivery, repair and maintenance, and social interactions.

### BRIEF DESCRIPTION OF THE DRAWINGS

FIG. 1 shows one embodiment of a user interface for capturing user profile information;

FIG. 2 shows another embodiment of a user interface for capturing user profile information;

FIG. 3 shows yet another embodiment of a user interface for capturing user profile information;

FIG. 4 is a depiction of one embodiment of a system of the invention, and

FIG. 5 shows another embodiment of a user interface, which in this embodiment allows users to make a selection for services or other interactions.

### DETAILED DESCRIPTION OF THE INVENTION

Due to time constraints or mobility issues, people may need help with day-to-day activities. For people living alone, especially the elderly, there is also a feeling of connectedness that is often missing from their lives. Being social creatures, humans enjoy interacting with others and feeling that they are part of a community.

Social media sites like Facebook allow people to exchange messages, post pictures and arrange video calls with specific individuals. However, there is an absence of being part of an interactive community and the ability to meet and regularly engage with new people. The present invention provides a platform for people to interact at various levels: from helping with home and professional activities, to engaging in interactive discussions, games and exercises.

In one implementation of the system of the present invention, an App allows users to register, or sign in and provide some details about themselves that are geared toward the kinds of activities that they would like to partake in.

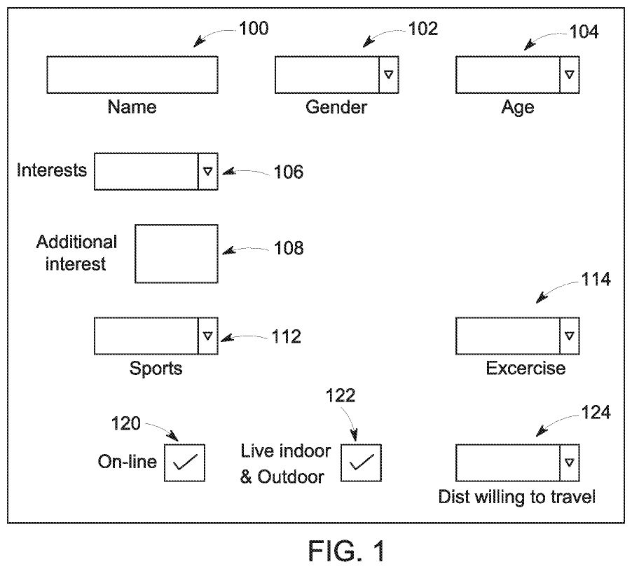

For example, if their interest is purely social, one embodiment of a user (also referred to herein as a customer) profile capture page is shown in FIG. 1. Users may specify their name (data block 100); gender (optional data entry 102); age (optional data entry 104); interests (drop-down menu 106 and data block 108 for additional interests), the kinds of group activities they may wish to share in (from discussion groups on a variety of topics, to sports, exercise, and games), based on drop down menus 112, 114. Users can specify whether they wish to only participate in on-line activities or would like to include indoor or outdoor activities elsewhere (as defined by check boxes 120, 122) and the distance they'd be willing to travel (drop down menu 124).

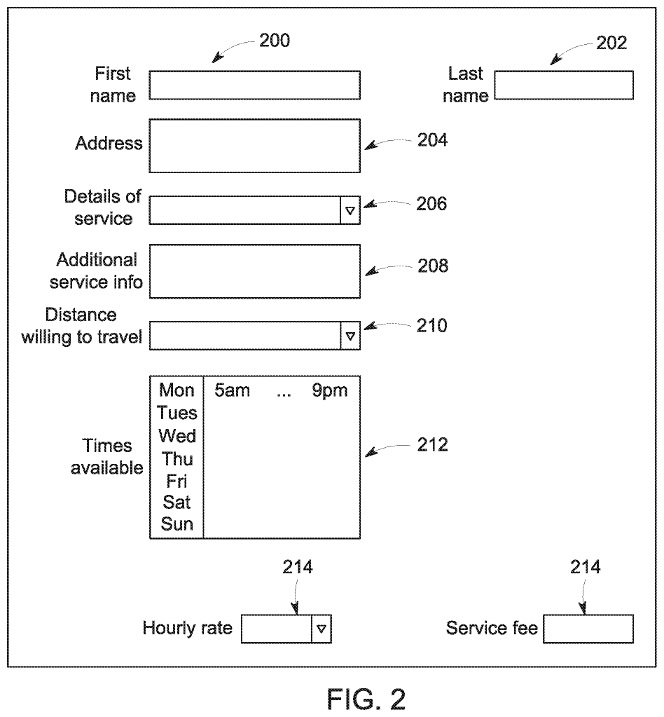

If the user is interested only in providing services (also referred to herein as a service provider), one embodiment of a profile capture page is shown in FIG. 2, which includes their name (data blocks 200, 202), and address (data blocks 204). Service providers, will also be able to provide details about the services they wish provide, which in this embodiment is defined in terms of a drop-down menu 206 and a data entry block 208 for adding additional information or services not included in the drop-down menu 206. Block 210 allows them to specify the distance they are willing to travel, and block 212 details the times and days they will be available. Block 214 defines the fee structure for their services.

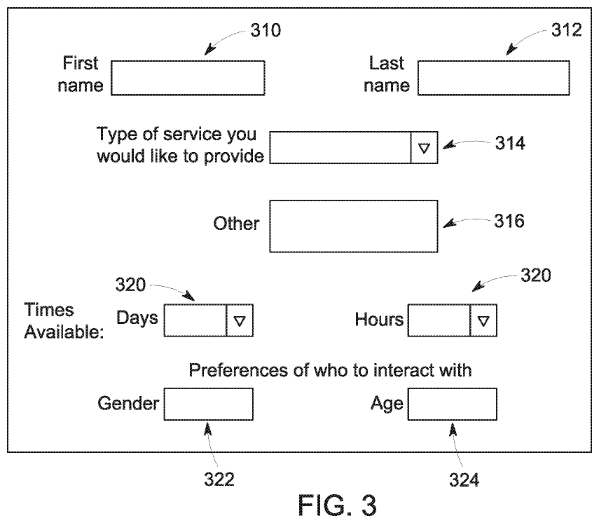

Some services may also be offered free-of-charge, e.g. a child offering to read to or chat with an elderly person on-line. In these cases the non-fee service provider is presented with a simplified data capture page; one embodiment of such a data capture page is shown in FIG. 3, which includes the provider's first name (block 310) and optional last name (block 312). The service description, in this embodiment comprises a drop-down menu of items to choose from (block 314) and a data entry block 316 for other services. Blocks 320 define a time availability field, which in this embodiment includes a day selection drop down menu and hour selection drop down menu, both of which allow entries to be saved and edited. In another embodiment, the user could be presented with a calendar for selecting year, month, day, and times. The user in the present embodiment is provided with a set of preferences of who they wish to interact with in terms of age (block 322) and gender (block 324). For instance, a girl may wish to read to, or converse, with an elderly person, and may choose to limit this to interactions with women.

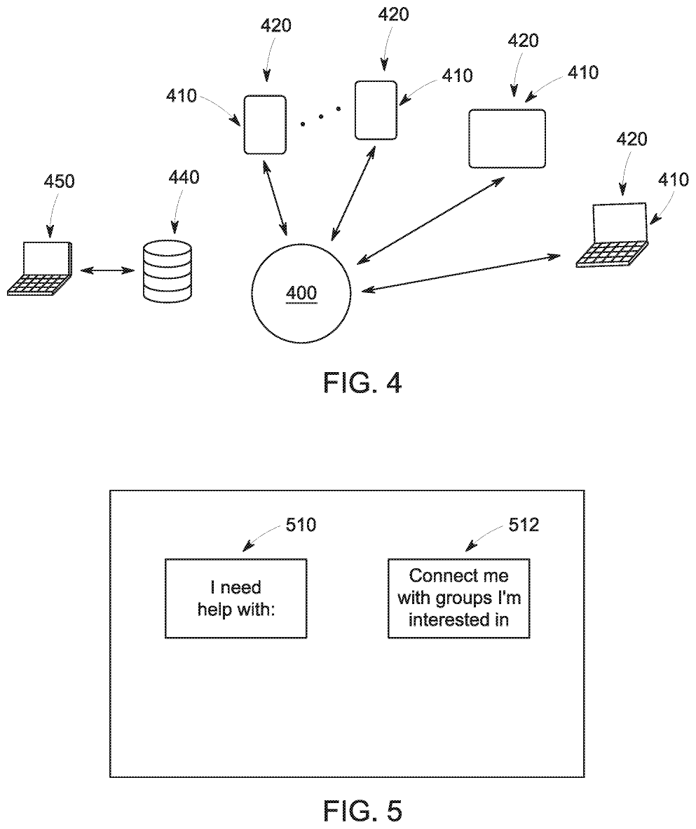

FIG. 4 is a depiction of one embodiment of a service platform of the present invention. An on-line platform 400 is accessible by means of user devices 410 (also referred to herein as clients) which may include smart phones, tablets, laptops, etc. The platform 400 in this embodiment is implemented as an interactive web app or downloadable software app (collectively, referred to herein as an App).

As shown in FIG. 4, users 420 who are in need of services or other assistance (also referred to herein as requestors), connect to the platform 400 using their user devices 410.

Having filled in their profile information, they are presented with a main or home page, one embodiment of which is shown in FIG. 5. The home page presents the user with options of choosing between service requests (selection box 510: “I Need Help With . . . ”) and social interaction requests (selection box 512: “Connect Me with Groups I'm Interested In”). Both boxes 510, 512, when clicked or selected by a user, present the user with a list of options. In the case of selection box 510 the user is presented with services offered by service providers that have signed up on the system. Selection box 512 presents a list of activities (individual and interactive; paid and free) e.g. exercise videos, exercise groups meeting at specific times on-line, or exercise groups meeting live at a defined location at specified times.

It will be appreciated that as people interact and meet other people on the platform, they may identify additional shared interests, resulting in the creation of additional services of social groups. Thus, a recipient of services or participant in an activity may form a new service or a new social group, e.g. by using the service provider user interface embodiment discussed above with respect to FIG. 2. In one implementation, the details of all service providers are captured in a database 440 (FIG. 4), which may be provided on a server supporting the platform 400 or at a client 450 connected to the server.

When a user selects a service that requires payment, the request is processed by presenting the user with a payment capture page, e.g. Name and address confirmation and payment details, e.g. PayPal, credit card, etc. and the necessary details for payment processing, as is known in the art. Once the payment information has been processed, the user is presented with a confirmation page.

Often more than one service provider may be available for a particular service request, based on type of service requested and geographic location. According to one aspect of the present invention, allocation of a service provider is based on price charged by the service providers, as is discussed in more detail below. The requestor may, in another embodiment, be presented with a provider allocation criterion, where requestor can select by price, or speed of delivery (urgency), or rating level (as discussed further below). Once the system allocates a service provider, the requester is presented with the provider's calendar and can select a time for the service. In the present embodiment, both the confirmation of a data and time by the requestor, and a subsequent confirmation by the requestor of the completion of the services, are tracked and saved.

Once the service has been performed, the service provider's page includes a Complete button. Logic at the server 440 receives the Complete signal and generates an invoice that is emailed to the user together with a rating form for rating the service provided by the service provider. The server 440 also processes the payment to the service provider.

Thus, the requestor is also presented with the ability to rate the service, e.g., on a scale of 1-10, which may be used by other requestors as a selection criterion, and may over time be used to determine whether to retain the provider or cancel such person from the platform if they consistently fall below a minimum rating level e.g. 8 out of 10. This allows an allocation of provider based on cost to still remain in line with an expectation of quality.

As discussed above, in another embodiment, the requester is given a choice to select a provider based on urgency, rather than cost, in which case an algorithm (implemented as machine readable code on a storage medium that is accessible by a processor on the server at the database 440 or on the client 450) accesses all possible service providers for a service request based on type of service and location, and identifies the first available provider based on each provider's availability/calendar profile (e.g. Details captured in block 212 of the user interface profile capture page discussed with respect to FIG. 2).

The platform of the present invention provides the advantage to users of making available vetted services. Instead of simply having a Yelp rating, for instance, the lists of service providers are constantly updated to ensure that users are only presented with providers that are consistently of a high quality.

Also, by presenting users with social groups that they can join, as well as the flexibility to create new social group, the present platform addresses the needs of people to socialize and interact with others having similar interests (whether it be discussion groups, book reviews, sporting activities, stamp collecting, etc.). It also accommodates different schedules and limitations of users, including geographic, time, mobility, and health constraints.

While the present invention has been described with respect to several specific embodiments, it will be appreciated that the system of the invention can be implemented in different ways without departing from the scope of the invention.

What is claimed is:

1. A system for providing service support, comprising
a portal that includes a service provider dashboard for capturing service provider details, and a service requester portal for submitting a service request,
a processor coupled with memory that includes machine readable code defining an algorithm, for allocating one or more service providers capable of addressing the service request.

2. A system of claim 1, wherein the services include paid and unpaid services.

3. A system of claim 2, wherein the paid services include yardwork, house cleaning, home maintenance, shopping and home delivery, and meals.

4. A system of claim 2, where the services include professional services that are provided virtually or face-to-face.

5. A system of claim 2, wherein the services include wellness and entertainment activities.

6. A system of claim 5, wherein the services include on-line gaming with a focus on interacting with others, exercise activities (both individual and group exercises), and socializing activities with one or more other individuals.

7. A system for providing service support, comprising a portal for capturing user details, and for users to post services and submit requests for services,
a processor coupled with memory that includes machine readable code defining an algorithm, for receiving a request for services from a requesting user, and allocating a corresponding services from one or more service provider users that are capable of addressing the request for services.

8. A system of claim 7, wherein the portal includes one or more lists of services that the user can select from.

9. A system of claim 8, wherein the services include social interactions as part of social groups and gatherings that have live or virtual get-togethers.

10. A system of claim 7, wherein portal includes a satisfaction feedback page for rating services that requesting users have received.

11. A system of claim 7, wherein the user details include one or more of name, age, gender, and interests of the user, and payment information to pay for paid services.

12. A system of claim 7, wherein user details for a service provider user includes availability information and location information of the user.

13. A system of claim 12, wherein the user details of the service provider user includes one or more of name, gender, preferences about users that the service provider user wishes to provide services to, and fee information for the services.

14. A method for improving the life of users, comprising
providing a portal that supports service providers in listing their services, and supports service requesters in selecting from available services, with both parties having the opportunity to provide at least one of gender and age-related information to allow personal preferences to be included by service providers in their offerings, and personal preferences to be included by users in selecting a service provider, the method further providing a rating service to allow users to provide feedback on the service.

15. A method of claim 14, wherein the services include, home delivery, repair and maintenance, and social interactions.
